(19) United States
(12) Patent Application Publication
(10) Pub. No.: US 2006/0008169 A1
(43) Pub. Date: Jan. 12, 2006

(54) Red eye reduction apparatus and method

(76) Inventors: Anna Yaping Deer, Lexington, KY (US); Khageshwar Thakur, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/883,119

(22) Filed: Jun. 30, 2004

(51) Int. Cl. G06K 9/40

(52) U.S. Cl. 382/254

(57) ABSTRACT

A method, and an apparatus employing the method, of reducing red eye effect from image data having image attributes. In some embodiments, the method includes identifying image data with a first image attribute having characteristics of red eye pixels, determining a centroid of the identified image data having characteristics of red eye pixels, defining a red eye region based on the centroid, and filling each of the pixels in the red eye region with a color determined from an equation relating to a distance between the centroid and each of the pixels.

### CROSS REFERENCES TO RELATED APPLICATIONS

This patent application is related to the U.S. patent application Ser. No. ______, filed MONTH DAY, 2004, entitled “Method and Apparatus for Effecting Automatic Red Eye Reduction” and assigned to the assignee of the present application.

### STATEMENT REGARDING FEDERALLY SPONSORED RESEARCH OR DEVELOPMENT

None.

### REFERENCE TO SEQUENTIAL LISTING, ETC

None.

### BACKGROUND

1. Field of the Invention

The present invention relates to processing of an image, and more particularly to processing of an image having red eye effect.

2. Description of the Related Art

Red eye effect is a common phenomenon in flash photography. In some environments, (e.g., in dim or dark places), the iris of an eye is opened wide for better viewing. When a flash is used for taking a picture in such environments, a burst of light is reflected from blood cells of the pupil, thereby producing a red eye effect in the resulting image. Images with red eye effect can look unrealistic and often unsightly. Correcting or reducing the red eye effect therefore enhances image perception. However, identifying eye regions having red eye effect is often difficult, due to nearby red pixels that are not part of the red eye effect. Moreover, since the eye is considered an important feature of a face, any mistake in red eye effect correction or reduction is often readily detected and unacceptable.

### SUMMARY OF THE INVENTION

Accordingly, there is a need for an improved technique for reducing red eye effect in images. To this end, some embodiments of the present invention use an apparatus and method for building a boundary table for red eye colors to identify red eye pixels. Also, some embodiments of the present invention use an apparatus and method for locating red eye regions, such as by using a boundary table. Some embodiments of the present invention use an apparatus and method for reducing red eye using data from the red eye regions and changing the color of the red eye in such regions.

In one form, the invention provides a method of identifying a red eye from image data that has image attributes. The method includes determining a plurality of image attribute from the image data, and selecting from the determined image attributes a select image attribute. The method also includes grouping the determined image attributes with respect to the select image attribute, and setting an image attribute boundary based on the determined image attributes for the select image attribute.

In another form, the invention provides a method of centering a red eye region of an image. The method includes determining a region of the image that includes a portion of the red eye, selecting a pixel from the region where the pixel represents an initial red eye center, and dividing the region into a plurality of circular regions centered around the initial red eye center, each circular region having a radius measured from the initial red eye center. The method also includes counting a red eye pixel number for each circular region, and locating a centroid of the red eye pixels when the red eye number is less than a red eye pixel threshold for the radius.

In yet another form, the invention provides a method of reducing red eye effect of a red eye centered at a pixel. The method includes defining a first red eye region and a second red eye region round the pixel. In some embodiments, the second red eye region envelopes the first red eye region, and has a plurality of second region pixels. The method also includes filling pixels in the first region with a first color, measuring a distance for each of the second region pixels from the pixel, and filling the second region pixel with a second color based on the distance.

In yet another form, the invention provides a method of reducing red eye effect from image data having image attributes. The method includes identifying image data with a first image attribute that has characteristics of red eye pixels, and determining a centroid of the identified image data having characteristics of red eye pixels. The method also includes defining a red eye region based on the centroid, and filling each of the pixels in the red eye region with a color determined from an equation relating to a distance between the centroid and each of the pixels.

In yet another form, the invention provides a method of identifying a pixel having image attributes that are characteristics of red eye effect. The method includes retrieving a plurality of boundary points with respect to at least one of the image attributes, drawing a line from the at least one of the image attributes of the pixel to each of the boundary points, and determining if an angle between adjacent lines exceeds an angle threshold.

In yet another form, the invention provides an apparatus of reducing red eye effect from image data having image attributes. The apparatus includes a first image attribute identifying software code that identifies the image data with a first image attribute having characteristics of red eye pixels. The apparatus also includes centroid identifying software code to determine a centroid of the identified image data having characteristics of red eye pixels, and red eye region defining software code to define a red eye region based on the centroid. The apparatus also includes filler software code to fill each of the pixels in the red eye region with a color determined from an equation relating a distance between the centroid and each of the pixels.

Other features and advantages of the invention will become apparent to those skilled in the art upon review of the following detailed description, claims, and drawings.

### BRIEF DESCRIPTION OF THE DRAWINGS

The patent or application file contains at least one drawing executed in color. Copies of the patent or patent application publication with color drawings(s) will be provided by the Office upon request and payment of the necessary fee.

FIG. 1 shows a flow chart of a red eye boundary construction method 100 according to an embodiment of the invention.

FIG. 2 shows an image attribute boundary plot produced in accordance with an embodiment of the invention.

FIG. 3 shows a flow chart of a color identification method according to an embodiment of the invention.

FIG. 4 shows a first point of an image under examination, wherein the first point is located inside the image attribute boundary of FIG. 2.

FIG. 5 shows a second point of an image under examination, wherein the second point is located inside the image attribute boundary of FIG. 2.

FIG. 6 shows a flow chart of a red eye identification method according to an embodiment of the invention.

FIG. 7A shows an eye having a pupil reacting to a flash

FIG. 7B shows the eye of FIG. 7A having a suggested center, minimum radius and a maximum radius of a red eye region to be examined.

FIG. 7C shows the red eye region with maximum radius of FIG. 7B, subdivided into a plurality of concentric circular rings.

FIG. 7D shows a centroid of a plurality of red eye pixels inside the red eye region.

FIG. 7E shows the centroid of FIG. 7D inside a circle having a derived radius.

FIG. 7F shows the eye of FIG. 7A having a core area and a periphery area.

FIG. 7G shows the eye of FIG. 7A having a corrected pupil.

FIG. 7H shows a partially open eye having a pupil reacting to a flash.

FIG. 8 shows a flow chart of a red eye reduction method according to an embodiment of the invention.

FIG. 9 shows an output profile 900 of the red eye reduction method illustrated in FIG. 8.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. In addition, the terms “connected” and “coupled” and variations thereof are not restricted to physical or mechanical connections or couplings.

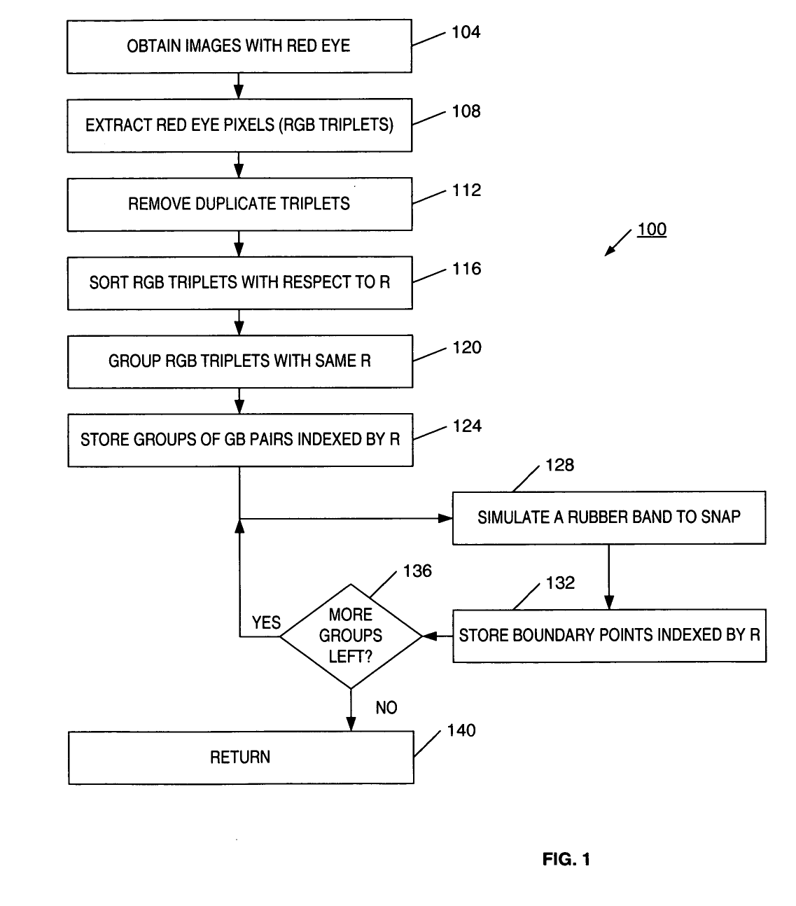

Before the reduction of red eye effects is made in an image, the red eye effects are identified. In many cases, the success of red eye effect reduction is at least partially dependent upon accurate identification of such red eye effects. However, identifying red eye effect can be particularly difficult because what constitutes a red eye color in an image can be a skin color in another part of the image or in another image. As a result, a first step of the red eye reduction process according to some embodiments of the present invention is to accurately identify red eye effects, or red eyes. To identify red eyes, a red eye boundary table can be constructed. FIG. 1 shows a flow chart of a red eye boundary construction method 100 according to an embodiment of the invention.

The red eye boundary construction method 100 illustrated in FIG. 1 starts with a sampling of image attributes from a large number of images (as illustrated approximately 20 images were used) with red eyes at block 104, although samples from a relatively small number of images (and samples from even a single image) can instead be used. In some embodiments, the image attributes are colors identified in any form, such as in (R, G, B) triplets contained in the image. In the embodiment of FIG. 1, the red eye colors are determined in (R, G, B) or RGB triplets color space, although any other type of color space can be used. At block 108, RGB triplets are extracted from pixels having image characteristics of red eye effects. Thereafter, duplicate triplets are removed at block 112. As a result, only unique RGB triplets are stored in a red eye database.

As used herein and in the appended claims, the term “pixel” includes elements of any image comprising graphics and/or text. Also, the term “pixel” includes all such elements found on or in any medium, including without limitation image elements on a display screen, on a printed medium, and the like). Examples of pixels include LCD, CRT, and other display screen elements, and elements printed on any surface (e.g., pels, cells, dots, and the like).

For example, if the following (R, G, B) triplets are extracted from the red eye images in order to build a red eye database: (80, 00, 56), (78, 13, 33), (77, 33, 30), (78, 29, 33), (80, 26, 24), (78, 43, 37), (79, 10, 41), (77, 34, 27), (79, 39, 37), (79, 39, 37), (78, 26, 49), (79, 18, 34), (79, 37, 49), (79, 38, 32), (79, 41, 32), (80, 16, 35), (78, 38, 36), (80, 39, 73), (80, 27, 19), (77, 32, 27), (80, 39, 35), and (78, 13, 33). The underlined triplets indicated duplicate values and one triplet in each pair of the (79, 39, 37) and (78, 13, 33) triplets can be removed at block 112 as being duplicate or redundant data.

The extracted red eye image attributes (e.g., the (R, G, B) triplets) can be stored in a red eye database. This red eye database is a database of colors identified as red eye colors, and can be used to determine whether parts (e.g., pixels) of an image are part of a red eye, as will be described in greater detail below. Although such a red eye database can be constructed by sampling any number of red eyes from images, the red eye database can be constructed in any other manner, such as by specifying a number of red eye colors to be included in the database

Since a red eye database built from a limited number of samples is rarely (if ever) exhaustive, the red eye boundary construction method 100 according to some embodiments is configured to interpolate for missing points. To simplify the interpolation process, one of the extracted image attributes (e.g., one of the (R, or G, or B) triplets in an RGB triplet color space, or any other attribute in other spaces) can be selected to be a select image attribute, leaving behind one or more other extracted image attributes (e.g., a set of remaining extracted attributes). When image attributes such as (R, G, B) triplets are used, one of the R, G, and B triplets is selected to be a select image attribute. For example, in some embodiments, the select image attribute is R, and therefore the remaining attributes are G and B.

Once a select image attribute has been determined and selected, the extracted image attributes from the red eye image can be sorted with respect to the select image attribute at block 116. In the example discussed above, data sorted with respect to R includes (77, 32, 27), (77, 33, 30), (77, 34, 27), (78, 13, 33), (78, 26, 49), (78, 29, 33), (78, 38, 36), (78, 43, 37), (79, 10, 41), (79, 18, 34), (79, 37, 49), (79, 38, 30), (79, 39, 37), (79, 41, 32), (80, 00, 56), (80, 16, 35), (80, 26, 24), (80, 27, 19), (80, 39, 35), and (80, 39, 73).

Thereafter, the red eye boundary construction method 100 according to some embodiments of the present invention groups the sorted image attributes according to each of the select image attribute values at block 120. Depending on the number of the select image attribute values, there can be a large number of groups for the select image attribute. Continuing with the above example, the following remaining extracted attribute groups of (G, B) pairs are indexed by R. For the selected group attribute R=77, the (G, B) pairs are (32, 27), (33, 30), and (34, 27). For the selected group attribute R=78, the (G, B) pairs are (13, 33), (26, 49), (29, 33), (38, 36), and (43, 37). For the selected group attribute R=79, the (G, B) pairs are (10, 41), (18, 34), (37, 49), (38, 30), (39, 37), and (41, 32). For the selected group attribute R=80, the (G, B) pairs are (0, 56), (16, 35), (26, 24), (27, 19), (39, 35), and (39, 73). In this example, there are four R groups. These sorted groups of R-indexed (G, B) pairs can be stored in the red eye database at block 124 for further processing

At block 128, the red eye boundary construction method 100 in the illustrated embodiment sets an image attribute boundary on the remaining extracted image attributes for each of the select image attribute values. In general, the image attribute boundary is established to enclose the remaining extracted image attributes for each value of the select image attributes. Since the image attribute boundary can be represented by a set of boundary points, in some embodiments only the boundary points for each indexed attribute are stored at block 132. Thereafter, the process of setting an image attribute boundary at block 128 is repeated if there are more R groups to be analyzed. Otherwise, the red eye boundary construction method 100 stops at block 140. Although RGB triplets are used in the red eye boundary construction method 100 of the illustrated embodiment, other the red eye boundary construction method 100 can be used for establishing boundaries for other image attributes, or for image attributes defined in other manners. For example, the red eye construction method 100 can be used with other types of color spaces, such as luminance bandwidth chrominance (“YUV”), luminance chroma-blue chroma-red (“YCbCr”), L*ab, and L*CH color spaces.

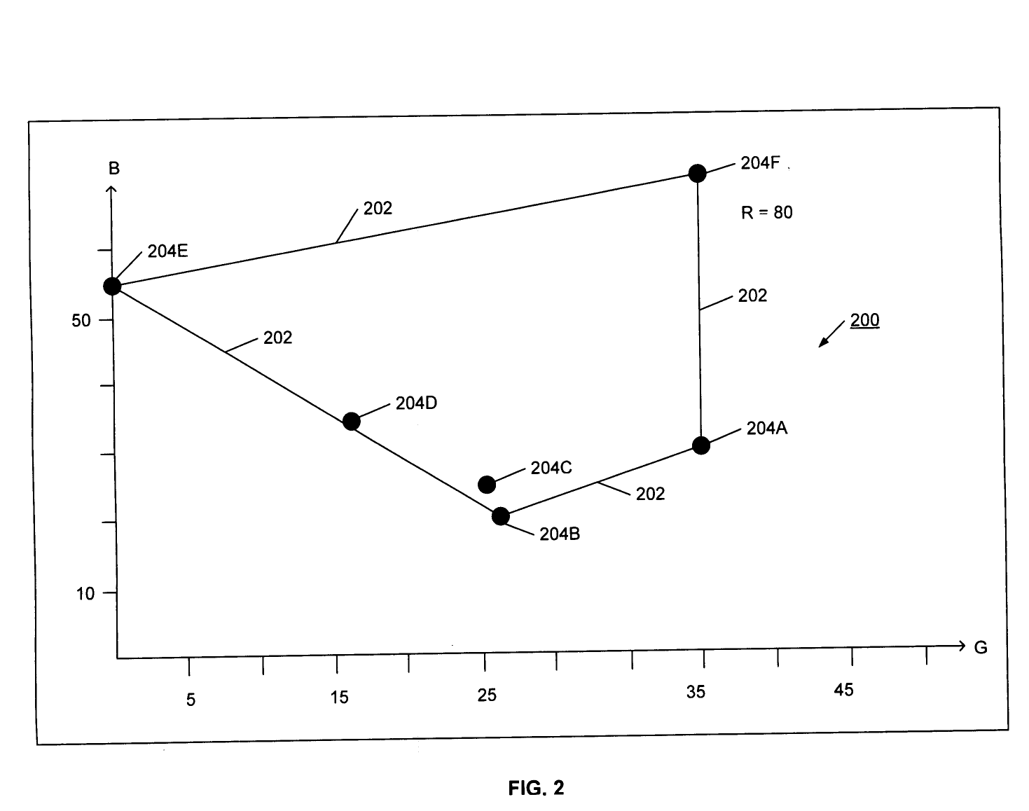

To find boundary points in the red eye construction method 100, some embodiment of the present invention use a grouping or “rubber banding” technique. For example, FIG. 2 shows a plot 200 of remaining extracted image attributes G (along the X-axis) and B (along the Y-axis) in the example described above, plotted against each other for one of the selected group attributes (R=80). In rubber banding, an imaginary rubber band or an image attribute boundary 202 is placed over the group of (G, B) pairs (e.g., 204A, 204B, 204C, 204D, 204E and 204F in the illustrated embodiment). Boundary points (pairs or vertices in FIG. 2) touching the imaginary rubber band are considered boundary points. Notice in FIG. 2 that there are six (G, B) pairs 204A, 204B, 204C, 204D, 204E and 204F, four of which—204A, 204B, 204E and 204F—form the image attribute boundary 202 for R=80. In the example described earlier, for R=77, the boundary points are (32, 27), (33, 30), and (34, 27). For R=78, the boundary points are (13, 33), (26, 49), (29, 33), and (43, 37). For R=79, the boundary points are (10, 41), (18, 34), (37, 49), (38, 30), and (41, 32). For R=80, the boundary points are (0, 56), (27, 19), (39, 35), and (39, 73). Accordingly, the red eye boundary construction method 100 in the illustrated embodiment only stores 16 out of the 20 (G, B) pairs, thereby reducing the size of the red eye database. In this way, a red eye table of four boundaries indexed by values of R can be constructed. In a similar manner, the red eye boundary construction method 100 according to other embodiments can determine a red eye boundary using any fraction of the image attribute points desired, such as those needed to encompass all or any desired threshold number or fraction of image attribute points.

Furthermore, the image attribute boundary 202 can include any number of points that are not part of the original samples (i.e., those falling within the image attribute boundary 202 but not specifically found in the samples used to construct the image attribute boundary 202. Also, the boundary table can be easily expandable in some embodiments. While the image attribute boundary table can be constructed earlier (e.g., as a default boundary), new data can be optionally added to the table. For example, when a red eye is found, the red eye boundary construction algorithm 100 can insert one or more image attributes of the new pixels in the sample, and can re-run the red eye boundary construction method 100 to generate a new boundary table. Such a process can take place automatically, in some embodiments.

As mentioned above, the red eye boundary construction method 100 can be used for establishing boundaries for other image attributes, or for image attributes defined in other manners. For example, in some embodiments, red eye colors from sampling of the eye can be converted from RGB color space to YCbCr color space. The converted YCbCr triplets can be stored in a database as (Y, Cb, Cr) triplets sorted with respect to Y. That is, the database or the table can be Y indexed. For each Y indexed group, the corresponding Cb, and Cr can be sorted with respect to their values. As a result, each Y-indexed group can be stored as 2-dimensional points. In other embodiments, image attribute boundaries having one or more additional dimensions (e.g., a three-dimensional image attribute boundary) can be constructed, such as by using image attributes having four values and in which three of the four values are used to construct points for the image attribute boundary.

In other embodiments, the red eye boundary table can be a 2-dimensional space of red eye colors of sampled images. For example, such a boundary table can have red eye colors defined by Cb and Cr values. In this way, the boundary table can be significantly smaller when compared with tables generated with 3-D RGB or YCbCr spaces. The smaller boundary table can therefore speed up look up processes. Similarly, red eye boundary tables can also be generated in any other space, such as in L*ab space and in L*CH space. In both of the L*ab and L*CH spaces, data can be sorted in the order of L*, a, and b, and, L*, C, and H, respectively. The sorted data can then be grouped by the index of L* value.

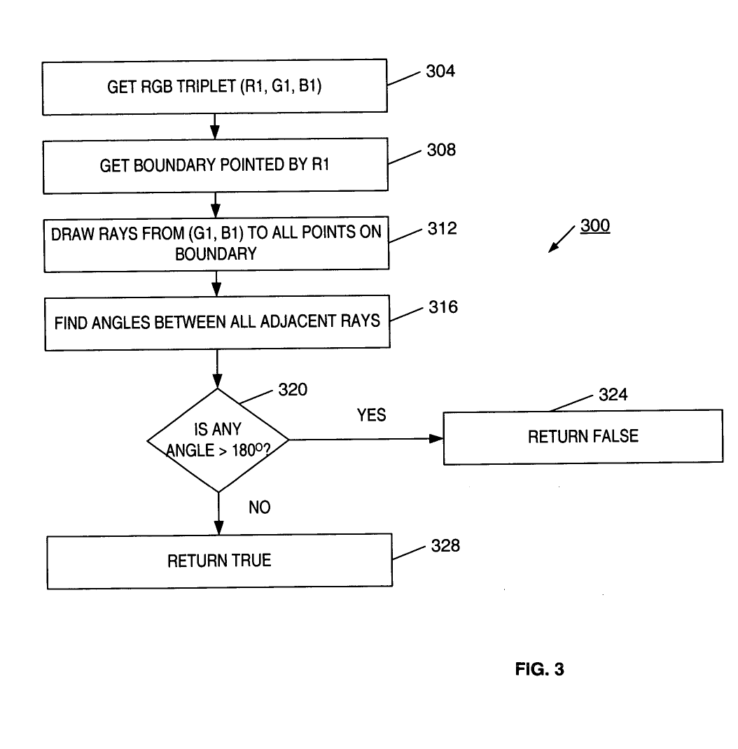

FIG. 3 shows a flow chart of a color identification method 300 according to an embodiment of the present invention. Once an image has been acquired, color RGB triplets of the image are determined at block 304. Color component R can then be extracted from the RGB triplets and matched with indexes from the table developed earlier. Once there is a match, the boundary points of the matched R index can be retrieved from the boundary table at block 308. In other embodiments, image attributes defined in other manners can instead be determined at block 304, any one of which can be extracted and matched with indexes from the table for retrieving boundary points at block 308.

In some embodiments, each pixel of an image is compared with boundary points to see if the pixel falls within the boundary. In this way, pixels whose colors are within the boundary points of the image attribute boundary retrieved at block 308 are considered red eye pixels. To determine if a pixel is inside the image attribute boundary indexed by R, in some embodiments rays can be drawn from the image attribute pair of the pixel (e.g., the R-indexed (G, B) pair in the illustrated embodiment) to the boundary points at block 312. Angles between all adjacent rays can thereafter be determined at block 316. If any of the determined angles exceeds an angle threshold, such as 180°, as determined at block 320, the pixel is considered to be outside the image attribute boundary. As a result, a “FALSE” is then returned at block 324, which means the pixel is likely not to have red eye characteristics. Otherwise, if all the determined angles are equal to or within the angle threshold (e.g., 180°), the pixel is considered to be inside the image attribute boundary. In such a case, a “TRUE” is then returned at block 328, which means the pixel is considered to have red eye characteristics.

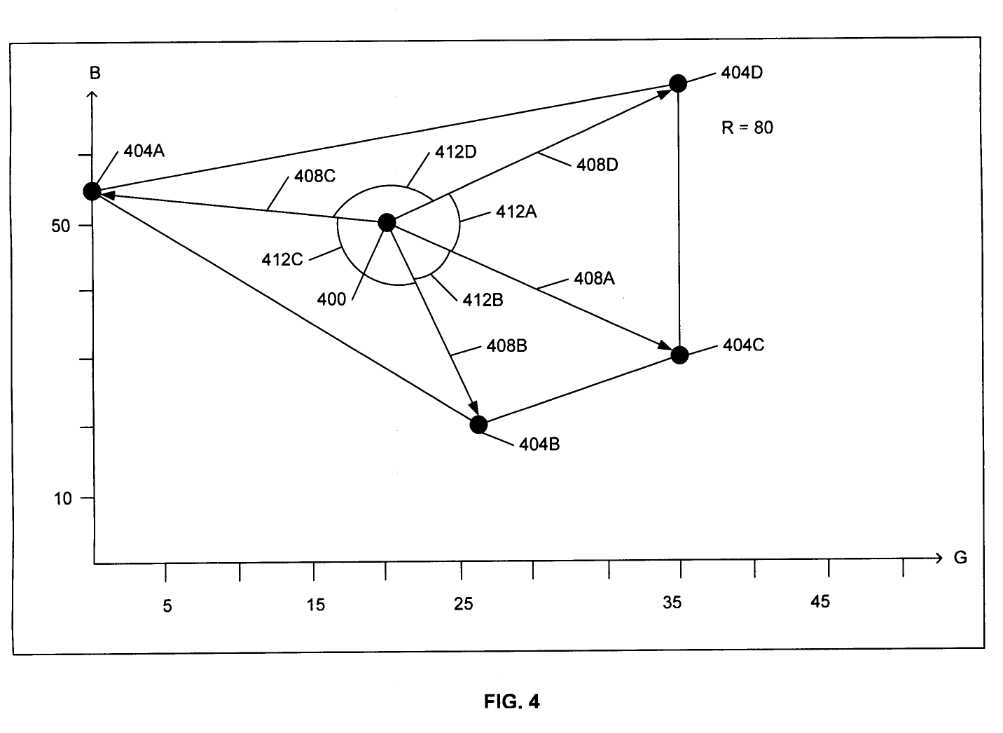

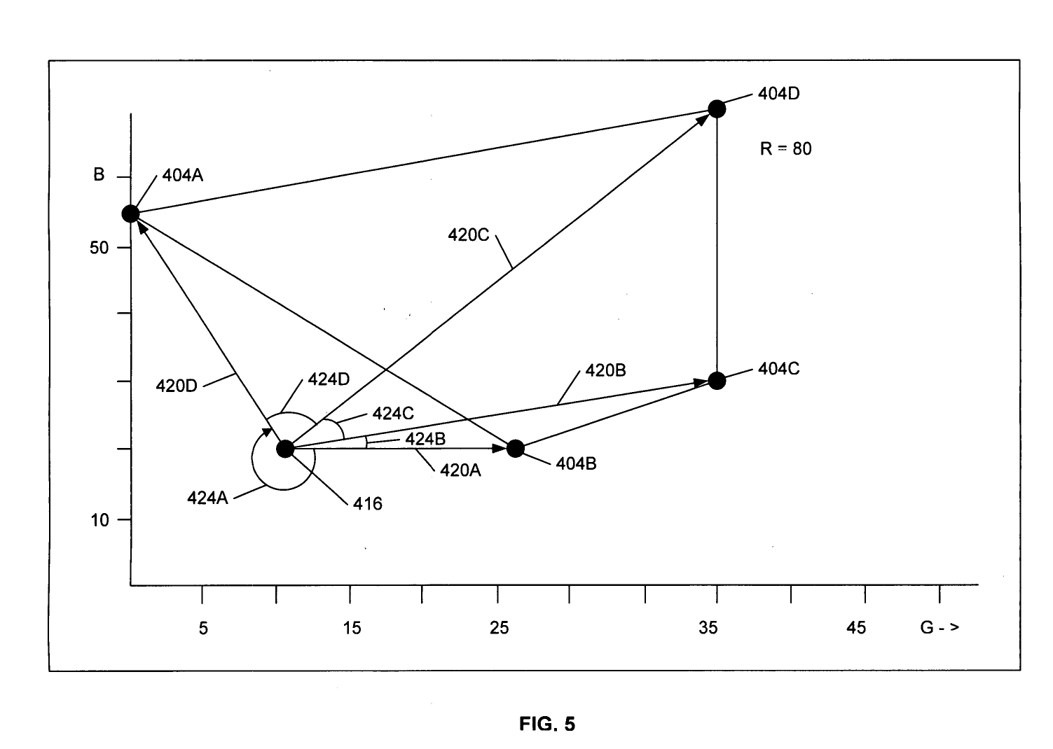

For example, FIG. 4 shows a pixel 400 located inside an indexed set of four boundary points 404A-404D. Specifically, the pixel 404 has RGB triplet values of 80, 20, and 50. The boundary points for R=80 are (0, 56) 404A, (27, 19) 404B, (39, 35) 404C, and (39, 73) 404D. Since there are four boundary points, four rays 408A, 408B, 408C, 408D are drawn from the pixel 400 at (20, 50). As a result, there are four angles 412A, 412B, 412C, and 412D between adjacent rays. Since all the angles are less than 180°, the pixel 400 is considered to have characteristics of red eye. Similarly, FIG. 5 shows a second pixel 416 having RGB triplet values of 80, 10, and 20, located outside an indexed set of boundary points 404A-404D. With the same boundary points 404A, 404B, 404C, and 404D, four rays 420A, 420B, 420C, 420D are drawn from the pixel 416 at (10, 20). As a result, there are four angles 424A, 424B, 424C, and 424D between adjacent rays. Since angle 424A is more than 180°, the pixel 416 is outside of the image attribute boundary, and is not considered to have characteristics of red eye. Again, even though color component R of the RGB triplets is used for sorting and indexing in the examples, any other components or other component of other color spaces as described can be used. Also, in other embodiments, other methods of determining whether a point in 2-dimensional space, 3-dimensional space, or other spaces fall within a boundary defined in such a space can be used. Any of such methods can be used in other embodiments to determine whether a pixel is within an image attribute boundary.

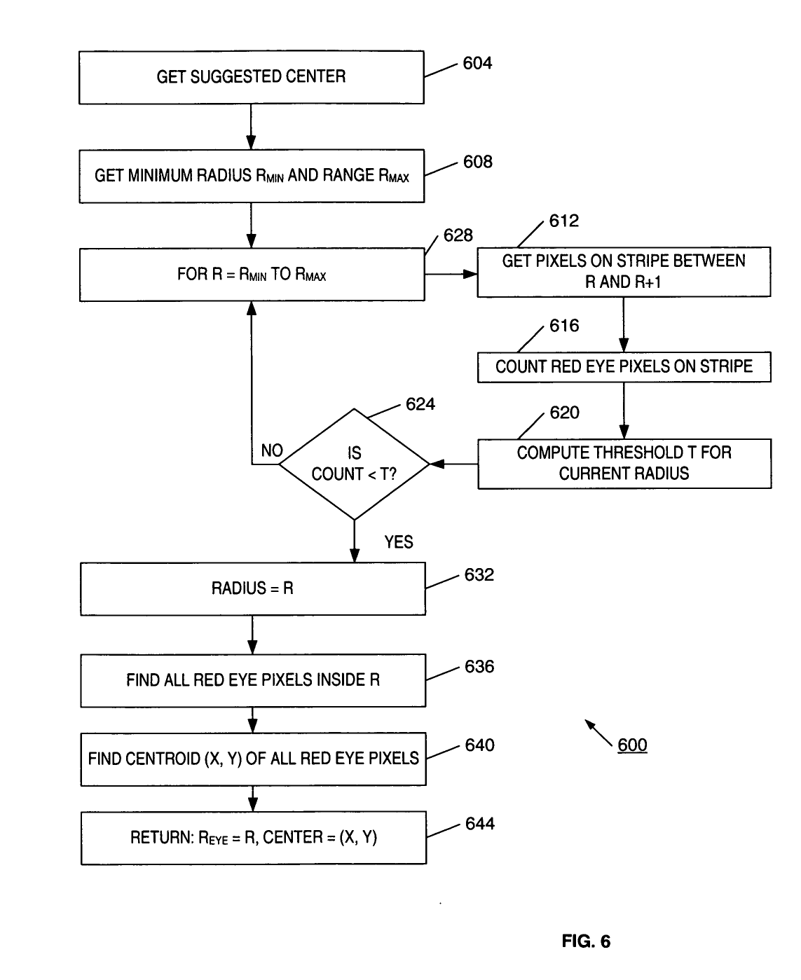

To identify the existence of a red eye in an image, any manual or automatic red eye detection method can be used. FIG. 6 shows a flow chart of a red eye identification method 600 according to an embodiment of the invention, and can be used after the location of a red eye has been manually or automatically determined. The red eye identification method 600 can be used to find an extent of red eye and to determine a center of the red eye. Initially, a pixel or other initial red eye center is provided at block 604, such as for example, from a user click of the image or by being determined by any other method. Assuming that the red eye lies within a certain range from the suggested pixel, the range can have a minimum range or radius and a maximum range or radius obtained at block 608. The minimum and maximum radii can be predetermined values, can be input by a user, or can be defined in any other manner. Futhermore, although the region is shown being circular in shape with a plurality of radii forming the ranges, the region can have any other shapes, such as a polygon, in other embodiments. In such cases, the ranges can be formed from the distance between the center of the polygon and a side of the polygon.

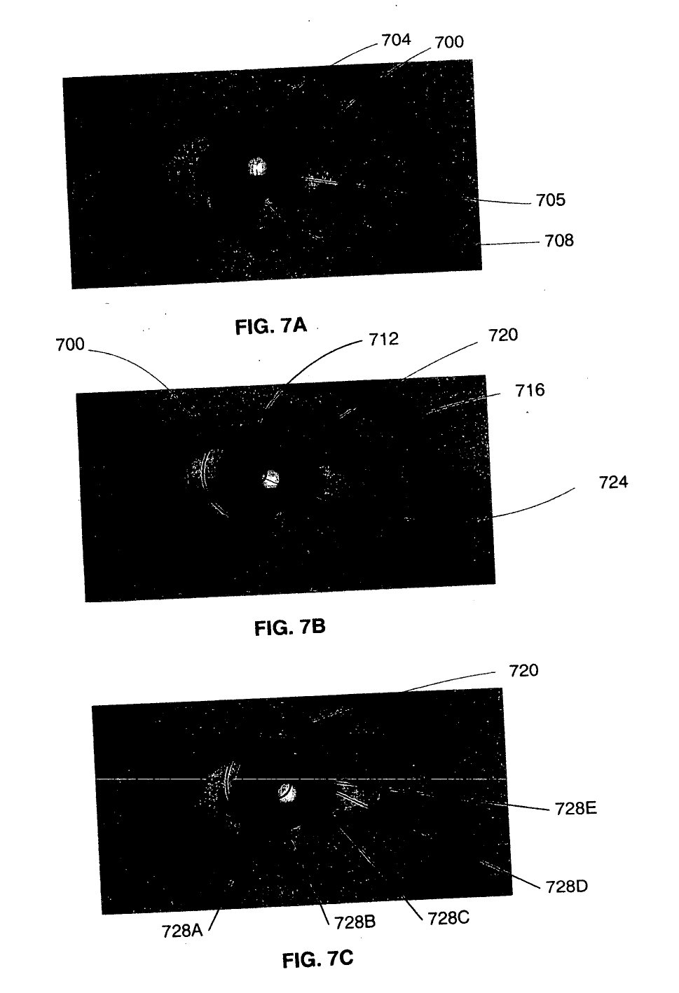

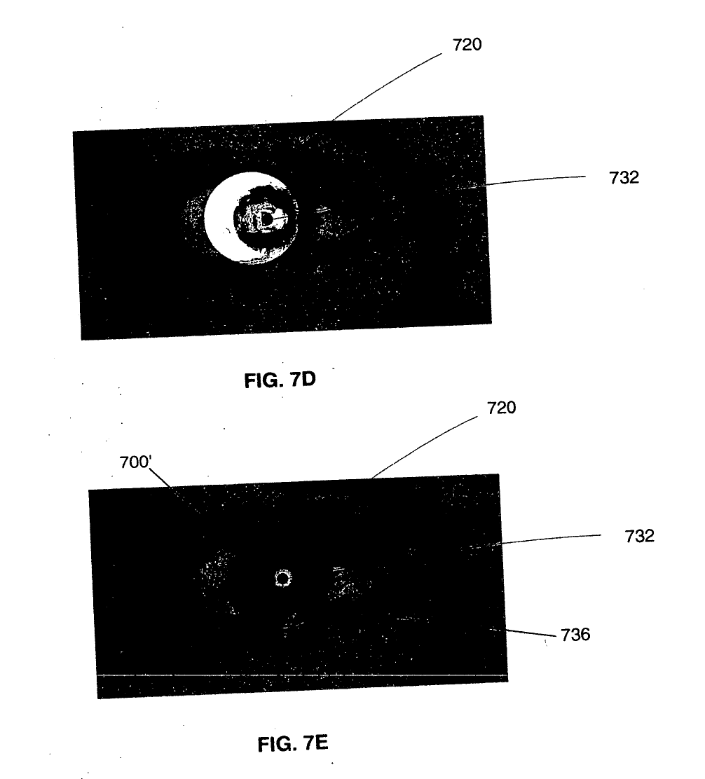

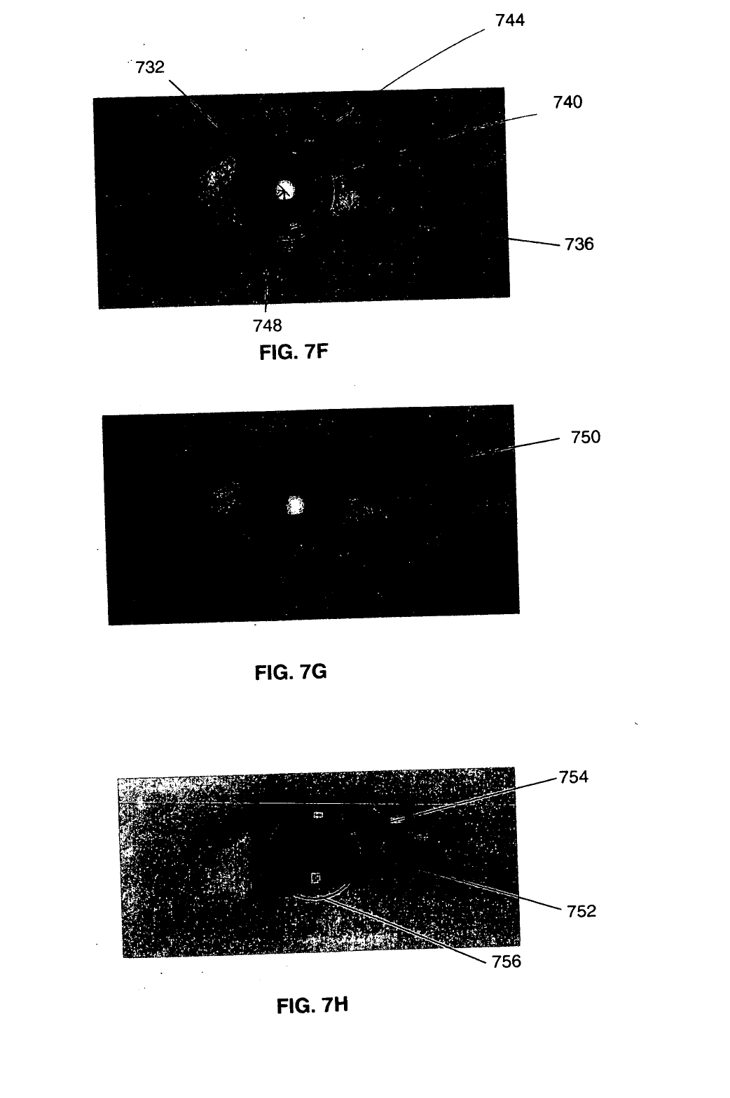

FIG. 7A shows an eye 700 having a pupil 704 reacting to a flash, and a white portion 708 reflecting the flash. The red eye region 705 lies within a range 712 (of FIG. 7B) from the suggested pixel. FIG. 7 B also shows the eye 700 (of FIG. 7A) having a minimum range or radius 716 and a maximum range or radius 720 as described above, with the minimum radius enclosing a suggested red eye center 724. That is, the maximum radius 720 is generally a sum of the range 712 and the minimum radius 716. The minimum radius, (R_{MIN}) 716, can be determined empirically, and in some embodiments is 1/16 inch (0.32 cm). Like (R_{MIN}), the range 712 can be generally determined empirically, and is ½ inch (1.27 cm) in radius in some embodiments. Of course, other values of the range 712 are also possible, depending at least in part upon the size of the image. While the minimum radius 716 and the range 712 are generally determined empirically in the illustrated embodiment, the minimum radius 716 and the range 712 can also be obtained by other methods.

Referring back to FIG. 6, the red eye identification method 600 can conduct a red eye search within the range 712. If nothing is found in the range 712 (e.g., if no pixels or an insufficient number of pixels are found having image attributes falling within an image attribute boundary as described above), an error code can be returned, and can indicate that the user has clicked on a wrong place of the image, or that the suggested red eye location is otherwise incorrect. To find an extent of red eye, the image or the eye 700 can be divided into a plurality of concentric circular rings 728A, 728B, 728C, 728D, and 728E, starting from the suggested red eye center 724 or the minimum radius 716 as shown in FIG. 7C. In some embodiments, the rings 728 can be equal or substantially equal in width. If the user suggested an initial red eye center at the central white portion 708 of a red eye (or if the method is provided with or determines such a suggested center in any other manner), the red eye identification 600 can start to search for red eye pixels from R_{MIN}. Although only five concentric circular rings 728A, 728B, 728C, 728D, and 728E are shown in FIG. 7C, any number of rings 728 can be used depending upon any number of factors, such as the size and/or shape of the eye 700. For each of the concentric circular rings 728A, 728B, 728C, 728D, 728E (i.e. at block 628 for R_{MIN} to R_{MAX}), the number of pixels can be counted at block 612. Also, a number of red eye pixels on each concentric circular rings 728A, 728B, 728C, 728D, and 728E can be counted at block 616.

As red eye pixels continue to be counted at greater radial distances, the area of the rings 728A, 728B, 728C, 728D, and 728E can increase in proportion to the distance between the ring 728 and the suggested red eye center 724 (such as for rings having the same width). As a result, assuming a uniform distribution of red eye pixels in a region of an image, additional rings can contain proportional increases in the number of red eye pixels. Therefore, the number of red eye pixels will increase as more rings are counted. At block 620, a red eye pixel threshold T is determined for a current concentric circular ring 728. In some embodiments, the red eye pixel threshold T for the current concentric circular ring 728 is determined as follows. If the distance between the outer perimeter (ring 728E) of the ring 728 being examined and the suggested red eye center 724 is R, and C is a constant determined empirically or with an algorithm, T=R×C. The value of C in some embodiments is about 1. Of course, the inner perimeter (ring 728A) of the ring 728 can also be used to calculate the red eye pixel threshold T, if desired. Also, the red eye pixel threshold for any of the rings 728A, 728B, 728C, 728D, and 728E can be calculated or set in any other manner desired.

In some embodiments, the number of red eye pixels counted in each ring 728A, 728B, 728C, 728D, and 728E is compared with the variable threshold, T. For example, as long as the red eye pixel count is greater T as determined at block 624, the counting continues onto a next circular ring at block 628. However, the ring in which the number of red eye pixels drops below the threshold T can be considered a boundary of the red eye region. When this ring is detected, the process of counting red eye pixels can stop and a derived radius of the red eye can then be set as the distance between the outer perimeter of this ring and the suggested red eye center 724 at block 632. In other embodiments, the derived radius can instead be set as the distance between the inner perimeter (728A) of the ring 728 and the suggested red eye center 724. Thereafter, at block 636 red eye pixels inside a circle formed by the derived radius can be located. In some embodiments at block 640, based on the locations of the red eye pixels, as shown in FIG. 7D, a centroid 732 of all the red eye pixels inside the circle can be determined. Thereafter, at block 644, the corrected center of the red eye can be set at the centroid 732, and a red eye radius, (R_{EYE}) 736 of the red eye 700 can be set to equal the derived radius. As a result, the red eye center 732 and the red eye radius 736 together form an estimated red eye 700′. In some embodiments (such as in those embodiments in which the derived radius of the red eye is set as the distance between the outer perimeter 728E of the ring 728 at which red eye pixel counting is stopped as described above and the suggested red eye center 724), the red eye radius, (R_{EYE}) 736 is overestimated by the red eye identification method 600. Overestimating the red eye radius (R_{EYE}) 736 can be useful in compensating for the color table, and in the process of gradually blending the edges of the red eye to reduce the red eye effect.

To reduce the red eye effect, in some embodiments all or any number of the pixels inside the estimated red eye region 700′ are replaced or filled with another color (e.g., a neutral color). In some embodiments, the estimated red eye region 700′ can be divided into a core or a first red eye region 740 and a periphery or a second red eye region 744 both centered at the red eye center 732, as shown in FIG. 7F. Although FIG. 7F shows that both the first and the second regions 740 and 744 are centered at the same pixel 732, the first and the second regions 740 and 744 can be centered at different points depending in some case upon the image and the application. The first region 740 can be an inner circle with a core radius, R_{CORE} 748, and the second red eye region 744 can include an area between R_{CORE} 748 and R_{EYE} 736. In some embodiments, the core radius, R_{CORE} 748 can be determined empirically. However, in other embodiments the core radius R_{CORE} 748 can be generated in other ways. The core radius R_{CORE} 748 can have any size, and in some embodiments has a size dependent upon the size of the red eye radius R_{EYE} 736. For example, the core radius R_{CORE} 748 in the illustrated embodiment is 80% of R_{EYE} 736.

The first red eye region 740 in the illustrated embodiment is likely to have red eye colors. Therefore, all the pixels inside the first red eye region 740 can be replaced or filled with another filling color (e.g., a neutral color). In some embodiments, the filling color can be a user-defined or a user-selected color defined or selected by a user. In yet some other embodiments, the filling color can be chosen from pixels near or adjacent to the red eye region by a user. For example, if two eyes have been detected in the image, and one of the two detected eyes does not have any red eye effect, the user can select the color of the unaffected eye to be the filling color for the other eye. This process can be performed while preserving the lightness of the red eye region 740. On the other hand, the second red eye region 744 may have a combination of red eye color, some color of the pupil, and skin color in any proportion. Thus, in some embodiments a distance measure is established to allow a gradual change in color. For example, for pixels adjacent to the first red eye region 740, the color of the pixels can be changed to another color (e.g., a neutral color). Colorfulness can be increased at any desired rate as the distance from the first red eye region 740 increases. The rate of change can be linear or non-linear as desired. In some embodiments, the rate of change is such that the colorfulness of a pixel farthest away from the center 732 is 100 percent. In other words, the color of the pixels farthest away from the center 732 will remain unchanged.

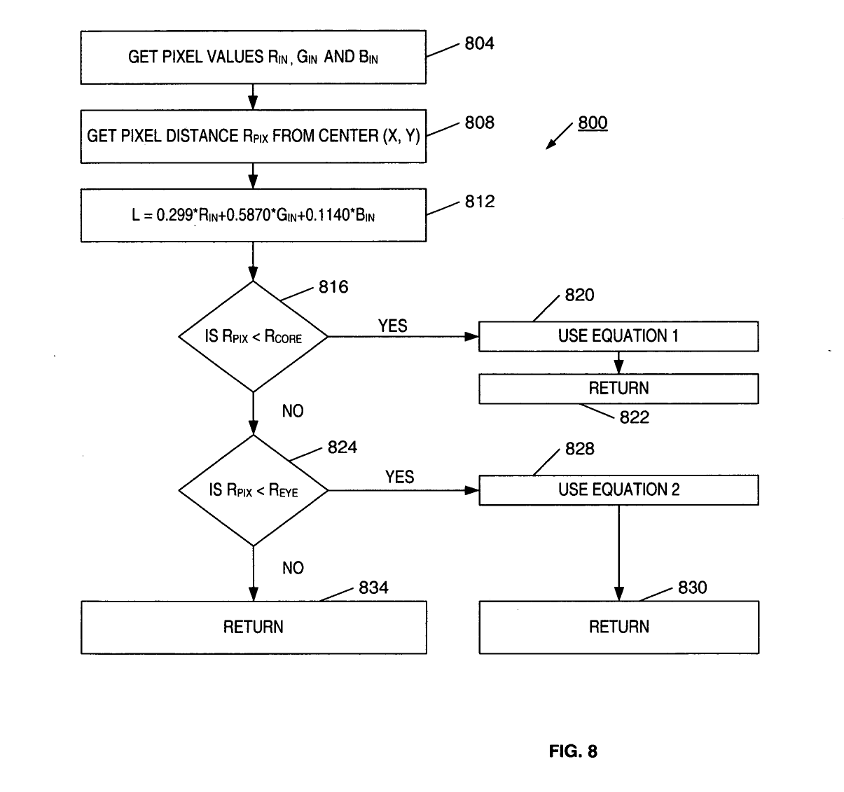

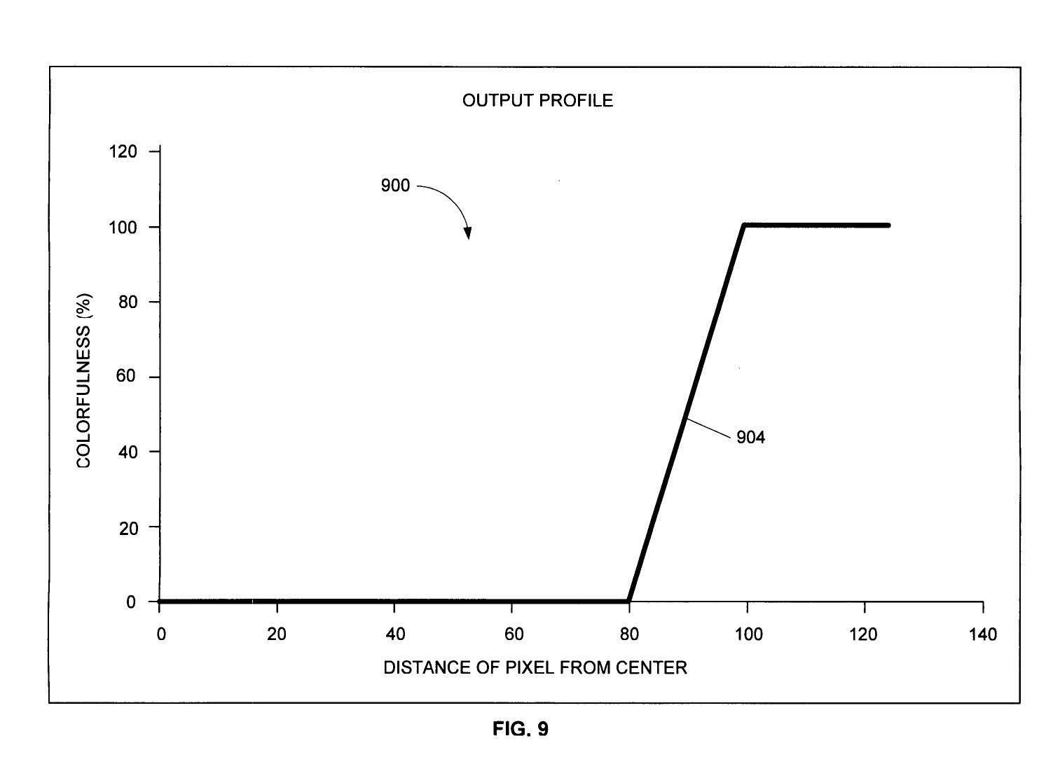

To illustrate a gradual change of color with changing radial distance in a red eye, FIG. 8 shows a red eye reduction method 800 according to an embodiment of the invention. At block 804, the value of attributes corresponding to (e.g., RGB triplets, R_{IN}, G_{IN} and B_{IN} in some embodiments) a pixel being examined is determined. Thereafter, the red eye reduction method 800 can determine a pixel distance R_{PIX} between the pixel being examined and the red eye center 732 at block 808. In some embodiments, a luminance level, L can be determined at block 812 using the following equation.
L=a₁ R_{IN}+a₂ G_{IN}+a₂ B_{IN}
where a₁, a₂, and a₃ are 0.299, 0.5870, and 0.1140, respectively, in some embodiments. Of course, other values of a₁, a₂, and a₃ can also be used in other applications. Also, other color space parameters (other than R_{IN}, G_{IN}, and B_{IN}), such as chrominance can instead be used. Thereafter, the pixel distance R_{PIX} is measured against the core radius, R_{CORE} 748 at block 816. If the pixel distance R_{PIX} is less than the core radius, R_{CORE} 748, the pixel being examined is considered inside the first region 740. In such a case, the pixel being examined can be filled with another color (e.g., a neutral color) at block 820. In some embodiments, the following equation, EQN. 1, can be used to convert the color:

$$\{ \begin{matrix}{R}_{OUT} = L \\ {G}_{OUT} = L \\ {B}_{OUT} = L\end{matrix} \} \qquad ( EQN . 1 )$$

where R_{OUT}, G_{OUT} and B_{OUT} are output colors. Once the values R_{OUT}, G_{OUT} and B_{OUT} have been determined, the red eye reduction method 800 stops at block 822. Otherwise, when the pixel distance R_{PIX} is at least equal to the core radius R_{CORE} 748, the red eye reduction method 800 can determine if the pixel distance R_{PIX} is less than the red eye radius, R_{EYE} 736 at block 824. If the pixel distance R_{PIX} is less than the red eye radius, R_{EYE} 736, the pixel being examined can be considered outside the first region 740 but inside the second red eye region 744. In such a case, the pixel being examined can be filled with a transitional color at block 828 and the red eye reduction method 800 stops at block 830. In some embodiments, the following equation, EQN. 2, can be used to fill in the transition color.

$$\{ \begin{matrix}{R}_{OUT} = \frac{{R}_{IN} ( {R}_{PIX} - {R}_{CORE} ) - L ( {R}_{PIX} - {R}_{EYE} )}{( {R}_{EYE} - {R}_{CORE} )} \\ {G}_{OUT} = \frac{{G}_{IN} ( {R}_{PIX} - {R}_{CORE} ) - L ( {R}_{PIX} - {R}_{EYE} )}{( {R}_{EYE} - {R}_{CORE} )} \\ {B}_{OUT} = \frac{{B}_{IN} ( {R}_{PIX} - {R}_{CORE} ) - L ( {R}_{PIX} - {R}_{EYE} )}{( {R}_{EYE} - {R}_{CORE} )}\end{matrix} \} \qquad ( EQN . 2 )$$

Otherwise, the red eye reduction method 800 can simply keep the original color of the pixel and stops at block 834. If, at block 824, R_{PIX} is not less than R_{EYE}, the method stops at block 836. FIG. 7G shows the eye of FIG. 7A having a corrected pupil 750.

FIG. 9 shows an output profile 900 of a red eye reduction method 800 according to the present invention where colorfulness=0 refers to a neutral color, colorfulness=100 refers to full color or an original color, input radius (R_{EYE}) is 100 pixels, and R_{CORE} is 80 pixels. The output profile shows that the red eye reduction method 800 can be used to avoid a hard transition in the eye color, and can generate a gradual color transition 904 of pixels located between 80 percent and 100 percent of the radius of the red eye radius R_{EYE} 736. The red eye reduction method 800 can also make less aggressive pixel color changes at greater radial distances from the red eye center 732. The red eye reduction method 800 can also be useful in correcting the red eye effect in partially open eyes. FIG. 7H shows an example of a partially open eye 752 with a partially covered pupil 754. In such cases, only part of the pupil 754 is represented by a circle 756. The circle 756 either leaves some red eye region or contains other images that are not characteristics of the eye. Having a gradual change or the gradual transition 904 in the second region 744 smoothes the transition between changing and not changing the pixel color in such cases. To further reduce possible artifacts resulting from the red eye reduction, a mild blurring of pixels inside the circle can be applied by replacing the pixel attribute values (e.g., pixel color triplets) by an average of the attribute values of the pixel being examined and a plurality of adjacent pixels.

It should be noted that the various aspects of the invention described herein need not necessarily be used together in a single system or method. In this regard, any of the various aspects of the present invention (e.g., red eye boundary construction, red eye identification, red eye reduction, and the like) can be used alone or in any combination with other aspects while still falling within the spirit and scope of the present invention.

Various features and advantages of the invention are set forth in the following claims.

1. A method of identifying a red eye from image data having image attributes, the method comprising the acts of:
determining a plurality of image attributes from the image data;
selecting from the determined image attributes a select image attribute;
grouping the determined image attributes with respect to the select image attribute; and
setting an image attribute boundary based on the determined image attributes.

2. The method of claim 1, and wherein the image attributes comprise at least one of RGB triplet, luminance bandwidth chrominance (“YUV”), luminance chroma-blue chroma-red (“YCbCr”), and L*ab, and L*CH attributes.

3. The method of claim 1, and wherein grouping the determined image attributes further comprises the acts of:
extracting the select image attribute from the image data to obtain at least one remaining image attribute; and
sorting the at least one remaining image attribute based on the extracted image attribute for the image data.

4. The method of claim 1, and wherein setting an image attribute boundary further comprises the act of rubber banding a plurality of image data having the determined image attributes.

5. The method of claim 1, further comprising the act of removing duplicate image data having same determined image attributes.

6. The method of claim 1, further comprising the act of storing the image attribute boundary.

7. The method of claim 1, further comprising the act of indexing the image attribute boundary.

8. The method of claim 1, and wherein the image attribute boundary comprises a plurality of boundary image data points.

9. A method of centering a red eye region of an image, the method comprising the acts of:
selecting a pixel from the image, the pixel representing an initial red eye center;
dividing the image into a plurality of circular regions centered around the initial red eye center;
counting a red eye pixel number for each region; and
locating a centroid of the red eye pixels when the red eye pixel number is less than a red eye pixel threshold for the region being counted.

10. The method of claim 9, further comprising the act of determining a minimum red eye radius.

11. The method of claim 9, further comprising the act of determining a maximum red eye range.

12. The method of claim 9, wherein the region comprises a circular shape, and wherein the circular regions each have a common radial width.

13. The method of claim 9, wherein the region comprises a circular shape, wherein the circular region being counted has a radius measured from the initial red eye center, the method further comprising the act of setting the measured radius to a red eye radius of the red eye.

14. The method of claim 9, further comprising setting the centroid to a red eye center of the red eye.

15. The method of claim 9, further comprising the act of updating the pixel threshold for the circular region being counted.

16. The method of claim 9, and wherein the red eye pixel threshold comprises a variable threshold based on the circular region being counted.

17. A method of reducing red eye effect of a red eye centered at a center pixel, the method comprising the acts of:
measuring a distance between a pixel in the red eye and the center pixel; and
filling the pixel with a color based on the distance.

18. The method of claim 17, further comprising the act of defining a first red eye region and a second red eye region around the pixel based on the distance, the second red eye region containing the first red eye region, and the second red eye region having a plurality of second region pixels.

19. The method of claim 17, wherein filling the pixel further comprises the act of:
filling pixels in a first region of the red eye with a first color; and
filling pixels in a second region pixel with a second color based on the distance.

20. The method of claim 17, wherein the color comprises at least one of a user selected color.

21. The method of claim 20, wherein the user selected color comprises a color chosen from adjacent pixels.

22. The method of claim 17, further comprising the act of determining at least one image attribute of the red eye.

23. The method of claim 22, and wherein the image attribute comprises at least one of RGB triplet, luminance bandwidth chrominance (“YUV”), luminance chroma-blue chroma-red (“YCbCr”), and L*ab, and L*CH attributes.

24. The method of claim 22, further comprising the act of determining a luminance based on the image attribute of the red eye.

25. The method of claim 17, further comprising the act of determining a color equation based on the distance from the center pixel.

26. The method of claim 17, wherein the pixel has an original pixel color, the method further comprising the act of keeping the original pixel color for the pixel when the distance of the pixel exceeds a distance threshold.

27. A method of reducing red eye effect from image data having image attributes, the method comprising the acts of:
identifying image data with a first image attribute having characteristics of red eye pixels;
determining a centroid of the identified image data having characteristics of red eye pixels;
defining a red eye region based on the centroid; and
filling each of the pixels in the red eye region with a color determined from an equation relating a distance between the centroid and each of the pixels.

28. The method of claim 27, further comprising the acts of:
determining a plurality of image attributes from the image data; and
selecting from the determined image attributes the first image attribute.

29. The method of claim 27, further comprising the act of grouping the identified image data with respect to the first image attribute.

30. The method of claim 27, further comprising the act of setting an image attribute boundary based on the identified image data.

31. The method of claim 27, and wherein the first image attribute comprises at least one of RGB triplet, luminance bandwidth chrominance (“YUV”), luminance chroma-blue chroma-red (“YCbCr”), and L*ab, and L*CH attributes.

32. The method of claim 27, and wherein the image data comprises a plurality of image attributes including the first image attribute, the method further comprising the acts of:
extracting the first image attribute from the identified image data to generate at least one remaining image attribute; and
sorting the at least one remaining image attribute based on the extracted first image attribute for the image data.

33. The method of claim 27, further comprising the act of bounding a plurality of image data having the first image attribute.

34. The method of claim 27, further comprising the act of removing duplicate image data having same image attributes.

35. The method of claim 27, further comprising the act of indexing the image data based on the first image attribute.

36. The method of claim 27, further comprising the acts of:
selecting a pixel from the image data, the pixel representing an initial red eye center; and
dividing the image data into a plurality of circular regions centered around the initial red eye center.

37. The method of claim 36, and wherein the circular regions each have a common radial width.

38. The method of claim 36, wherein each of the circular regions being counted has a radius measured from the initial red eye center, the method further comprising the act of setting the measured radius to a red eye radius of the red eye.

39. The method of claim 36, further comprising the act of setting the centroid to a red eye center of the red eye.

40. The method of claim 36, further comprising the act of counting a number of red eye pixels of the identified image data for each of the circular regions.

41. The method of claim 40, further comprising the act of locating the centroid of the red eye pixels when the number of red eye pixels is less than a red eye pixel threshold for the circular region being counted.

42. The method of claim 27, further comprising the act of determining a minimum red eye radius.

43. The method of claim 27, further comprising the act of determining a maximum red eye range.

44. The method of claim 27, wherein determining the centroid further comprises the act of determining a pixel threshold for the image data.

45. The method of claim 27, further comprising:
measuring a distance between a pixel in the red eye and the centroid; and
determining a new color of the pixel based on the distance.

46. The method of claim 27, further comprising the act of defining a first red eye region and a second red eye region of the red eye region based on the centroid, the second red eye region containing the first red eye region, and the second red eye region having a plurality of second region pixels.

47. The method of claim 27, wherein filling each of the pixels further comprises the act of:
filling each of the pixels in a first region of the red eye with a first color; and
filling each of the pixels in a second region pixel with a second color based on the distance.

48. The method of claim 27, further comprising the act of determining a luminance based on the first image attribute of the red eye.

49. The method of claim 27, further comprising the act of determining a color equation based on the distance from the centroid.

50. The method of claim 27, wherein each of the pixels has an original pixel color, the method further comprising the act of keeping the original pixel color for the pixel when the distance of the pixel exceeds a distance threshold.

51. The method of claim 27, wherein identifying the image data further comprises the acts of:
retrieving a plurality of boundary points associated with the first image attribute;
drawing a line from the image attributes characteristics of the image data to each of the boundary points; and
determining if an angle between adjacent lines exceeds an angle threshold.

52. The method of claim 51, wherein the angle threshold is about 180°, the method further comprising the acts of:
indicating the image data being outside of a boundary formed by joining the boundary points when the angle is greater than the angle threshold; and
indicating the image data being inside of the boundary when the angle is equal to or less than the angle threshold.

53. A method of identifying a pixel having image attributes characteristics of red eye effect, the method comprising the acts of:
retrieving a plurality of boundary points with respect to at least one of the image attributes;
drawing a line from the at least one of the image attributes characteristics of the pixel to each of the boundary points; and
determining if an angle between adjacent lines exceeds an angle threshold.

54. The method of claim 53, further comprising the act of extracting a plurality of image attributes from the image data.

55. The method of claim 54, and wherein the image attributes comprise at least one of RGB triplet, luminance bandwidth chrominance (“YUV”), luminance chroma-blue chroma-red (“YCbCr”), and L*ab, and L*CH attributes.

56. The method of claim 53, wherein the angle threshold is about 180°, the method further comprising the acts of:
indicating the pixel being outside of a boundary formed by joining the boundary points when the angle is greater than the angle threshold; and
indicating the pixel being inside of the boundary when the angle is equal to or less than the angle threshold.

57. An apparatus of reducing red eye effect from image data having image attributes, the apparatus comprising:
first image attribute identifying software code configured to identify the image data with a first image attribute having characteristics of red eye pixels;
centroid identifying software code configured to determine a centroid of the identified image data having characteristics of red eye pixels;
red eye region defining software code configured to define a red eye region based on the centroid; and
filler software code configured to fill each of the pixels in the red eye region with a color determined from an equation relating a distance between the centroid and each of the pixels.

58. The apparatus of claim 57, further comprising selection software code configured to select the first image attribute.

59. The apparatus of claim 57, further comprising grouping software code configured to group the identified image data with respect to the first image attribute.

60. The apparatus of claim 57, further comprising setting software code configured to set an image attribute boundary based on the identified image data.

61. The apparatus of claim 57, and wherein the first image attribute comprises at least one of RGB triplet, luminance bandwidth chrominance (“YUV”), luminance chroma-blue chroma-red (“YCbCr”), and L*ab, and L*CH attributes.

62. The apparatus of claim 57, wherein the image data comprises a plurality of image attributes including the first image attribute and the apparatus further comprises:
extraction software code configured to extract the first image attribute from the identified image data to generate at least one remaining image attribute; and
sorting software code configured to sort the at least one remaining image attribute based the extracted first image attribute for the image data.

63. The apparatus of claim 57, further comprising bounding software code configured to bound a plurality of image data having the first image attribute.

64. The apparatus of claim 57, further comprising removal software code to remove duplicate image data having same image attributes.

65. The apparatus of claim 57, further comprising indexing software code configured to index the image data based on the first image attribute.

66. The apparatus of claim 57, further comprising:
selection software code configured to select a pixel from the image data, the pixel representing an initial red eye center; and
divider software code configured to divide the image data into a plurality of circular regions centered around the initial red eye center.

67. The apparatus of claim 57, and wherein the circular regions each have a common radial width.

68. The apparatus of claim 57, wherein each of the circular regions being counted has a radius measured from the initial red eye center, the apparatus further comprising setting software code configured to set the measured radius to a red eye radius of the red eye.

69. The apparatus of claim 57, further comprising second setting software code configured to set the centroid to a red eye center of the red eye.

70. The apparatus of claim 57, further comprising counter software code configured to count a red eye pixel number of the identified image data for each of the circular regions.

71. The apparatus of claim 57, further comprising location software code configured to locate the centroid of the red eye pixels when the red eye pixel number is less than a red eye pixel threshold for the circular region being counted.

72. The apparatus of claim 57, further comprising determining software code configured to determine a minimum red eye radius.

73. The apparatus of claim 57, further comprising determining software code configured to determine a maximum red eye range.

74. The apparatus of claim 57, further comprising threshold determining software configured to determine a pixel threshold for the image data.

75. The apparatus of claim 57, further comprising:
measurement software code configured to measure a distance between a pixel in the red eye and the centroid; and
coloring software code configured to fill pixels with color based on the distance.

76. The apparatus of claim 57, further comprising defining software code configured to define a first red eye region and a second red eye region of the red eye region based on the centroid, the second red eye region containing the first red eye region, and the second red eye region having a plurality of second region pixels.

77. The apparatus of claim 57, wherein the filling software code further comprises:
first filling software code configured to fill each of the pixels in a first region of the red eye with a first color; and
second filling software code configured to fill each of the pixels in a second region pixel with a second color based on the distance.

78. The apparatus of claim 57, further comprising determining software code configured to determine a luminance based on the first image attribute of the red eye.

79. The apparatus of claim 57, further comprising determining software code configured to determine a color equation based on the distance from the centroid.

80. The apparatus of claim 57, wherein each of the pixels has an original pixel color, the filler software code is configured to keep the original pixel color for the pixel when the distance of the pixel exceeds a distance threshold.

81. The apparatus of claim 57, wherein the identifying software code further comprises:
retrieval software code configured to retrieve a plurality of boundary points associated with the first image attribute;
line drawing software code configured to extend a line from the image attributes characteristics of the image data to each of the boundary points; and
determining software code configured to determine if an angle between adjacent lines exceeds an angle threshold.

82. The apparatus of claim 81, wherein the angle threshold is about 180°, the apparatus further comprising:
indicating software code configured to indicate when the image data is outside of a boundary formed by joining the boundary points when the angle is greater than the angle threshold, and to indicate when the image data is inside of the boundary when the angle is equal to or less than the angle threshold.

83. The method of claim 47, and wherein the first color comprises a gray color, the method further comprising the acts of:
determining a luminance based on the first image attribute of the red eye; and
generating the gray color based on the luminance of the image data.

84. The method of claim 47, and wherein the second color comprises a transitional color, the method further comprising the acts of:
determining a luminance based on the first image attribute of the second region pixel; and
generating the transitional color based on the luminance of the image data using the following equation:
$$\{ \begin{matrix}{R}_{OUT} = \frac{{R}_{IN} ( {R}_{PIX} - {R}_{CORE} ) - L ( {R}_{PIX} - {R}_{EYE} )}{( {R}_{EYE} - {R}_{CORE} )} \\ {G}_{OUT} = \frac{{G}_{IN} ( {R}_{PIX} - {R}_{CORE} ) - L ( {R}_{PIX} - {R}_{EYE} )}{( {R}_{EYE} - {R}_{CORE} )} \\ {B}_{OUT} = \frac{{B}_{IN} ( {R}_{PIX} - {R}_{CORE} ) - L ( {R}_{PIX} - {R}_{EYE} )}{( {R}_{EYE} - {R}_{CORE} )}\end{matrix} \} .$$

85. The apparatus of claim 77, and wherein the first color comprises a gray color, the apparatus further comprising:
determining software code configured to determine a luminance based on the first image attribute of the red eye; and
generating software code configured to generate the gray color based on the luminance of the image data.

86. The apparatus of claim 77, and wherein the second color comprises a transitional color, the apparatus further comprising:
second determining software code configured to determine a luminance based on the first image attribute of the second region pixel; and
second generating software code configured to generate the transitional color based on the luminance of the image data using the following equation:
$$\{ \begin{matrix}{R}_{OUT} = \frac{{R}_{IN} ( {R}_{PIX} - {R}_{CORE} ) - L ( {R}_{PIX} - {R}_{EYE} )}{( {R}_{EYE} - {R}_{CORE} )} \\ {G}_{OUT} = \frac{{G}_{IN} ( {R}_{PIX} - {R}_{CORE} ) - L ( {R}_{PIX} - {R}_{EYE} )}{( {R}_{EYE} - {R}_{CORE} )} \\ {B}_{OUT} = \frac{{B}_{IN} ( {R}_{PIX} - {R}_{CORE} ) - L ( {R}_{PIX} - {R}_{EYE} )}{( {R}_{EYE} - {R}_{CORE} )}\end{matrix} \} \dot{=}$$
